(19) United States
(12) Patent Application Publication
(10) Pub. No.: US 2022/0122447 A1
(43) Pub. Date: Apr. 21, 2022

(54) SMART TAGS FOR COVERTLY PROMOTING HAND HYGIENE COMPLIANCE IN FOOD SERVICE INDUSTRIES

(71) Applicant: GOJO Industries, Inc., Akron, OH (US)

(72) Inventors: Jackson W. Wegelin, Stow, OH (US); Patrick Brown, Cleveland Heights, OH (US); Joseph S. Kanfer, Richfield, OH (US); Carol L. Wilson, Kent, OH (US); Tamara M. Cross, Uniontown, OH (US)

(21) Appl. No.: 17/502,100

(22) Filed: Oct. 15, 2021

Related U.S. Application Data
(60) Provisional application No. 63/093,473, filed on Oct. 19, 2020.

(51) Int. Cl. G08B 21/24; G08B 7/06; G06K 19/07

(52) U.S. Cl. CPC G08B 21/245; G06K 19/0723; G08B 7/06

(57) ABSTRACT

Exemplary embodiments of smart tags for covertly alerting a service worker to perform a hand hygiene event are disclosed herein. An exemplary smart tag includes a housing, a processor, memory, one or more rechargeable batteries, and a vibrator. The vibrator vibrates the badge and the vibrating badge produces less than 30 decibels of sound. The smart tag further includes a plurality of LEDs. The LEDs illuminate in a first sequence to indicated one of the service worker has washed or sanitized her hands and service worker needs to wash or sanitizer her hands. The smart tag further includes a graphic image that depicts one or more hands.

### RELATED APPLICATIONS

This application claims the benefits of, and priority to, U.S. Provisional Patent Application Ser. No. 63/093,473, filed on Oct. 19, 2020 and titled SMART TAGS FOR COVERTLY PROMOTING HAND HYGIENE COMPLIANCE IN FOOD SERVICE INDUSTRIES, and which is incorporated herein by reference in its entirety.

### TECHNICAL FIELD

The present invention generally relates to systems and methods for increasing hand hygiene compliance in food service industries. Particularly, the present invention relates to smart tags for providing covert reminders to food service workers to wash their hands without providing the same to customers.

### BACKGROUND OF THE INVENTION

Expensive compliance monitoring systems are used in some large hospitals and large institutions. These expensive compliance monitoring systems are designed to provide companies or institutions with knowledge relating to compliance with selected hand hygiene policies. The compliance monitoring systems are often complex and require badges or tags, networks, central computers and expensive programming. Such complex systems are not feasible in retain food service industries due to their cost and complexity.

There have been a few systems developed for use in industries, such as, for example, food service industries. For example, U.S. Pat. No. 5,952,924 titled Method and Apparatus for Enforcing Hygiene teaches use of a badge that has visual or audible indictors that the wearer's hands are unsanitary. An unsanitary condition is triggered by entering an area, such as a restroom, or by timing out. The enforcement appears to rely on the desire to “avoid unnecessary embarrassment” of having unsanitary hands. Other systems are large and complex systems that are very costly and not practical implementations for the food service industry, which often operate on very narrow profit margins.

In addition, solutions that inform the badge wearer of the sanitary condition of their hands tend to suffer from a major drawback as customers viewing the badges or tags utilizing the above mentioned features, can readily tell whether the person wearing the badge or tag has not properly washed or sanitized their hands. Accordingly, there is a need for a badge or smart tag that can be worn by food service personnel that can provide a covert indication to the wearer of the badge or tag that the food service personnel needs to wash or sanitize their hands, without alerting a customer.

### SUMMARY

Exemplary embodiments of smart tags for covertly alerting a service worker to perform a hand hygiene event are disclosed herein. An exemplary smart tag includes a housing, a processor, memory, one or more rechargeable batteries, and a vibrator. The vibrator vibrates the badge and the vibrating badge produces less than 30 decibels of sound. The smart tag further includes a plurality of LEDs. The LEDs illuminate in a first sequence to indicated one of the service worker has washed or sanitized her hands and service worker needs to wash or sanitizer her hands. The smart tag further includes a graphic image that depicts one or more hands.

Another exemplary smart tag for covertly alerting a service worker to perform a hand hygiene event includes a housing, a processor, memory, one or more rechargeable batteries and a covert indicator. The covert indicator is one of a vibrator for vibrating the badge at a decibel rating of below 30 decibels and one of a plurality of LEDs that illuminate in one or more sequences.

Another exemplary smart tag for covertly alerting a service worker to perform a hand hygiene event includes a housing, a processor, memory and a vibrator that vibrates the badge that produces less than 30 decibels of sound and a power source.

Another exemplary smart tag for covertly alerting a service worker to perform a hand hygiene event includes a housing, a processor, memory, a covert indicator and a power source. The covert indicator provides an indication to the service worker to perform a hand hygiene event and the covert indicator is not readily discernable by an observer of the service worker.

Another exemplary smart tag for covertly alerting a service worker to perform a hand hygiene event includes a housing, the housing having a top side and a bottom side, the top side has an arcuate shape having an apex located proximate the center of the housing. The bottom side has an arcuate shape having a low point located proximate the center of the housing. The smart tag further includes a processor, memory, a covert indicator, one or more LEDs, and a power source.

Another exemplary smart tag for covertly alerting a service worker to perform a hand hygiene event includes a housing. The housing has a top side and a bottom side. The top side has an arcuate shape having an apex located proximate the center of the housing. The bottom side has an arcuate shape having a low point located proximate the center of the housing. The smart tag further includes a processor, memory and a covert indicator. The processor activates the covert indicator to inform the service worker of the need to complete a hand hygiene event. A power source and a user input for causing the processor to deactivate the covert indicator are also included.

Another exemplary smart tag for covertly alerting a service worker to perform a hand hygiene event includes a housing that has a top side and a bottom side. The top side has an arcuate shape having an apex located proximate the center of the housing. The bottom side has an arcuate shape having a low point located proximate the center of the housing. The smart tag further includes a processor, memory and a covert indicator. The processor activates the covert indicator to inform the service worker of the need to complete a hand hygiene event. The smart tag also includes power source and wireless communication circuitry for receiving a signal from a dispenser indicative of the service worker has completed a hand hygiene event; and wherein the processor deactivates the covert indicator upon receipt of the signal.

Another exemplary smart tag for covertly alerting a service worker to perform a hand hygiene event includes a housing that has a top side and a bottom side. The top side has an arcuate shape having an apex located proximate the center of the housing and the bottom side has an arcuate shape having a low point located proximate the center of the housing. The smart tag further includes a processor, memory, a covert indicator, and a power source.

Another exemplary smart tag for covertly alerting a service worker to perform a hand hygiene event includes a housing, a processor, memory, means for covertly providing an indication to a wearer of the smart tag to perform a hand hygiene event and a power source.

Yet another exemplary smart tag for covertly alerting a service worker to perform a hand hygiene event includes a housing, a reprogrammable processor, memory, a covert indicator for covertly informing a wearer of the smart tag to provide a hand hygiene event, a header in circuit communication with the processor and a power source.

Still yet another exemplary smart tag for covertly alerting a service worker to perform a hand hygiene event includes a housing, a processor, memory, a covert indicator and a power source. The covert indicator provides an indication to the service worker to perform a hand hygiene event and the covert indicator is not readily discernable by an observer of the service worker.

### BRIEF DESCRIPTION OF THE DRAWINGS

These and other features and advantages of the present invention will become better understood with regard to the following description and accompanying drawings in which:

FIG. 1 is an exemplary embodiment of a smart tag having one or more covert indicators to indicate to a wearer of the smart tag a need to perform a hand hygiene event without indicating to a casual observer of the wearer of the smart tag that the wearer is in need of performing a hand hygiene event;

FIGS. 2-10 disclose exemplary embodiments of additional smart tags;

FIG. 11 illustrates an exemplary circuit diagram for an exemplary smart tag;

FIG. 12 is an exemplary embodiment of a logic diagram or methodology for a smart tag;

FIG. 13 is another exemplary embodiment of a logic diagram or methodology for a smart tag;

FIG. 14 is another exemplary embodiment of a logic diagram or methodology for a smart tag;

FIG. 15 is an exemplary embodiment of a smart tag and a dispenser; and

FIG. 16 is an exemplary embodiment of a charging station.

### DETAILED DESCRIPTION

The following includes definitions of exemplary terms used throughout the disclosure. Both singular and plural forms of all terms fall within each meaning. Except where noted otherwise, capitalized and non-capitalized forms of all terms fall within each meaning:

“Circuit communication” as used herein indicates a communicative relationship between devices. Direct electrical, electromagnetic and optical connections and indirect electrical, electromagnetic and optical connections are examples of circuit communication. Two devices are in circuit communication if a signal from one is received by the other, regardless of whether the signal is modified by some other device. For example, two devices separated by one or more of the following—amplifiers, filters, transformers, optoisolators, digital or analog buffers, analog integrators, other electronic circuitry, fiber optic transceivers or satellites—are in circuit communication if a signal from one is communicated to the other, even though the signal is modified by the intermediate device(s). As another example, an electromagnetic sensor is in circuit communication with a signal if it receives electromagnetic radiation from the signal. As a final example, two devices not directly connected to each other, but both capable of interfacing with a third device, such as, for example, a CPU, are in circuit communication. Circuit communication includes providing power to one or more devices. For example, a processor may be in circuit communication with one or more batteries, indicating that the batteries provide power to the processor.

Also, as used herein, voltages and values representing digitized voltages are considered to be equivalent for the purposes of this application, and thus the term “voltage” as used herein refers to either a signal, or a value in a processor representing a signal, or a value in a processor determined from a value representing a signal.

“Signal”, as used herein includes, but is not limited to one or more electrical signals, power signals, analog or digital signals, one or more computer instructions, a bit or bit stream, or the like.

“Logic,” synonymous with “circuit” as used herein includes, but is not limited to hardware, firmware, software and/or combinations of each to perform a function(s) or an action(s). For example, based on a desired application or needs, logic may include a software controlled microprocessor or microcontroller, discrete logic, such as an application specific integrated circuit (ASIC) or other programmed logic device. Logic may also be fully embodied as software. The circuits identified and described herein may have many different configurations to perform the desired functions.

Any values identified in the detailed description are exemplary and they are determined as needed for a particular dispenser and/or refill design. Accordingly, the inventive concepts disclosed and claimed herein are not limited to the particular values or ranges of values used to describe the embodiments disclosed herein.

The term “dirty hands” as used herein means that a wearer of the smart tag should perform a hand hygiene event and the term “clean hands” as used herein means that a wearer of the smart tag has performed a hand hygiene event within a selected period of time.

The term “covert indicator” as used herein means an indicator that is directed to a wearer of a smart tag that indicates a need for the wearer to wash or sanitize her hands, i.e. to conduct a hand hygiene event, but that does not inform the casual observer, that the wearer of the smart tag should perform a hand hygiene event. Accordingly, a covert indicator is not readily associated with the cleanliness status of the wearer's hand. The covert indicator may provide a tactile, a visible or audible indication to the wearer of the smart tag.

If the covert indication is a tactile indication, such as, for example, a vibrating mechanism, the vibration must be substantially silent to a casual observer when the smart tag is secured to the wearer. Substantially silent should be construed to mean that the vibrating smart tag cannot be heard outside of a three foot radius of the smart tag when worn by a user. In some embodiments, the audible level of the vibrating smart tag when worn by a user is less than about 30 decibels (dBs). In some embodiments, the audible level of the vibrating smart tag when worn by a user is less than about 25 decibels (dBs). In some embodiments, the audible level of the vibrating smart tag when worn by a user is less than about 20 decibels (dBs). In some embodiments, the audible level of the vibrating smart tag when worn by a user is less than about 15 decibels (dBs). In some embodiments, the audible level of the vibrating smart tag when worn by a user is less than about 10 decibels (dBs). In contrast, vibrators in objects such as, for example, pagers are not substantially silent and indeed are designed to provide an audible signal as well as a tactile signal to the wearer, are typically heard from greater than 3 feet from the wearer and are typically output a level of noise that louder than 30 decibels when worn by a user.

A covert indicator that is a visual indicator provides a visual signal that is not intuitively an indicator of clean or dirty hands. Examples of covert visual indicators include: a plurality of lights that light up in a first order indicative of clean hands and light up in a second order indicative of dirty hands; a logo having a first color (other than red) indicating dirty hands and a second color (other than green) indicating clean hands; one or more lights that flash in a first pattern indicative of clean hands and one or more lights that flash in a second pattern indicative of dirty hands; one or more images that have a first orientation indicative of dirty hands and a second orientation indicative of clean hands; display of a first shape for clean hands and a second shape for dirty hands; one or more lights located along the top of the smart tag that are visible when looking downward on the smart tag, but not visible when viewing the smart tag head on, or from slightly below as would be the case of a person sitting at a table and looking at the service worker. In some embodiments, the visual indicator is one or more benign colored lights. The term “benign colored lights” include colored lights that are not generally associated with good or bad. Benign colored lights include blue, blue-green, pastel colors, soft tones, blended colors, and the like. Examples of non-benign colored lights include red or orange, which are often associated with stop, danger or bad. In addition, colors combined with red and orange are typically not covert. Other examples of visual indicators that are not covert include: a red light indicative of dirty hands; a red or orange light for dirty hands and any other colored light indicative of clean hands; a light “on” indicative of one of clean and dirty hands and no light on indicative of the other of clean or dirty hands; and a flashing light indicative of dirty hands, or the like.

A covert indicator that is a covert audible indicator should be an subtle indicator, such as, for example, all or portion of a song, tune or jingle, and a whistle. Examples of non-covert audible indicators include an alarm, a beep, a voice instructing the user to perform a hand hygiene event.

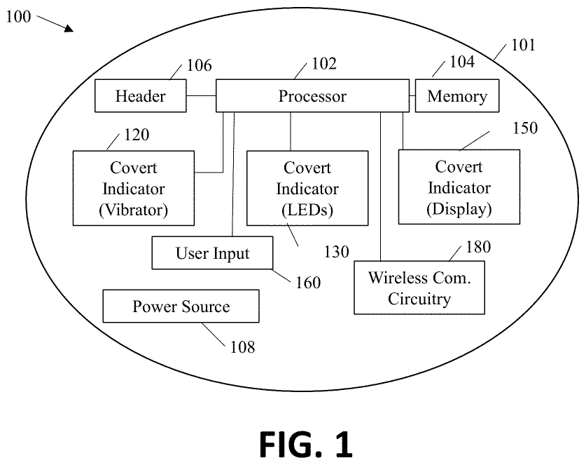

FIG. 1 is an exemplary embodiment of a smart tag 100 having one or more covert indicators to indicate to a wearer of the smart tag a need to perform a hand hygiene event without indicating to a casual observer of the wearer of the smart tag that the wearer is in need of performing a hand hygiene event. Smart tag 100 includes a housing 101. Located within the housing 101 is a processor 102, memory 104, a header 106, a power source 108, a first covert indicator 120, a second covert indicator 130, a third covert indicator 150, a user input 160; wireless communication circuitry 180 and one or more indicator lights 190. In some embodiments, the smart tag does not contain all of the disclosed elements of FIG. 1. The only required components in a basic smart tag are housing 101, processor 102, memory 104, power source 108 and one of the convert indicators 120, 130 or 150. In some embodiments, the basic smart tag includes one or more of the additional elements identified in FIG. 1. In one embodiment, basic smart tag includes header 106. In one embodiment, the basic smart tag includes user input 160, but not wireless communication circuitry 180; in one embodiment, the basic smart tag includes covert indicator 120 and one or more additional light sources, such as, for example, one or more LEDs, and in some embodiments, the additional light sources are not covert indicators.

Processor 102 may be any type of processor, such as, for example a microprocessor, or the like. In this exemplary embodiment, processor 102 is in circuit communication with optional header 106. Header 106 is a connection port so that a user can connect to the system circuitry to manually program the circuitry, run diagnostics on the circuitry, and/or retrieve information from the circuitry. The header 106 is a physical connection that requires a user to physical connect a device to the system circuitry.

Processor 102 is in circuit communication with memory 104. Memory 104 may be include any type of memory, such as, for example, Random Access Memory (RAM); FLASH memory, Read Only Memory (ROM); programmable read-only memory (PROM), electrically programmable read-only memory (EPROM), electrically erasable programmable read-only memory (EEPROM), or the like, or combinations thereof. In some embodiments, the memory 104 is separate from the processor 104 and in some embodiments, the memory 104 resides on, or within, processor 104.

A power source 108 is included. Power source 108, may be, for example, one or more batteries. In some embodiments, power source 108 is one or more coin cell batteries, in some embodiments, power source 108 is one or more AAA batteries, and in some embodiments, power source 108 is one or more AA batteries, and some embodiments, power source 108 is three AA batteries. Power source 108 provides power to the circuit elements as required and as readily known. In a preferred embodiment, power source 108 is one or more rechargeable batteries.

Smart tag 100 includes one or more covert indicators 120, 130 and 150. Only one covert indicator is required. In this exemplary embodiment, optional first cover indicator 120 includes a vibrator. The vibrator, may be, for example, a small motor with an eccentric weight. The first covert indicator 120 provides a tactile indication to the wearer. In some embodiments, the first covert indicator 120 is configured to be substantially silent to a casual observer of the wearer standing about three feet from the wearer. In some embodiments, the first covert indicator 120 is configured to be substantially silent to a casual observer of the wearer standing about two feet from the wearer. In some embodiments, the first covert indicator 120 is configured to be substantially silent to a casual observer of the wearer standing about one foot from the wearer. In some embodiments, covert indicator 120 is configured to output a noise level of less than about 30 dBs. In some embodiments, covert indicator 120 is configured to output a noise level of less than about 25 dBs. In some embodiments, covert indicator 120 is configured to output a noise level of less than about 20 dBs. In some embodiments, covert indicator 120 is configured to output a noise level of less than about 15dBs. In some embodiments, covert indicator 120 is configured to output a noise level of less than about 10 dBs.

Smart tag 100 includes optional covert indicator 130. In this exemplary embodiment, optional covert indicator 130 includes one or more lights. The one or more lights may be, for example, light emitting diodes (LEDs) or an LED bar. The LEDs may be any benign color or combinations of benign colors. The LEDs are controllable by processor 102. In some embodiments, the plurality of lights light up in a first order indicative of clean hands and light up in a second order indicative of dirty hands. In some embodiments, one or more lights that flash in a first pattern indicative of clean hands and one or more lights that flash in a second pattern indicative of dirty hands. In some embodiments, the one or more lights blink at a first rate to indicate clean hands and a second rate to indicate dirty hands. In some embodiments, the lights turn on and off in a first direction of travel to indicate clean hands and an opposite direction of travel to indicate dirty hands. In some embodiments, a first intensity of one or more lights indicate clean hands and a second intensity of one or more lights indicate dirty hands.

In some embodiments, one or more LEDs may be operated at a selected frequency and at a selected duty cycle that conserves power while appearing to the user to be one. In some exemplary embodiments, the frequency is less than 60 hertz (hz). In some exemplary embodiments, the frequency is about 50 hz. In some embodiments, the frequency is between 30 hz and 60 hz. In some exemplary embodiments, the duty cycle is less than about a 50% duty cycle. In some exemplary embodiments, the duty cycle is less than about a 40% duty cycle. In some exemplary embodiments, the duty cycle is less than about a 30% duty cycle. In some exemplary embodiments, the duty cycle is less than about a 20% duty cycle. In some exemplary embodiments, the duty cycle is about a 10% duty cycle. In one embodiment, the covert indicator were multiple LEDs that were operated at 50 hz with a 10% duty cycle. In this embodiment, power consumption dropped 90 percent when compared to the LEDs operated at a 100% duty cycle.

Smart tag 100 includes optional covert indicator 150. In this exemplary embodiment, optional covert indicator 150 is a display, such as, for example, a liquid crystal display (LCD), an electrochromic display (ECD), or the like. In some embodiments, the display displays a logo having a first color (other than red) indicating dirty hands and a second color (other than green) indicating clean hands. In some embodiments, the display displays an image in a first orientation to indicate clean hands and a second orientation to indicate dirty hands. In some embodiments, the display displays a first benign image to indicate clean hands and a second benign image to indicate dirty hands. In some embodiments, the image is a first shape to indicate clean hands and a second shape to indicate dirty hands.

The exemplary smart tag 100 includes an optional user input 160. User input 160 may be, for example, a switch, such as a push button switch, a toggle switch or the like. Optional user input 160 may be used to reset the covert indicator from dirty hands indication to a clean hands indication. Thus, when the wearer performs a hand hygiene event, the user may initiate the user input to change or reset the covert indicator to indicate that the person performed the requisite hand hygiene event.

In some exemplary embodiments, the smart tag 100 has a timer programed in processor 102 that provides for a set time to indicate that a wearer has clean hands or has performed a hand hygiene event within the set time period. When the timer expires, the covert indicator is activated and the wearer is provided with a covert indication that she needs to complete a hand hygiene event. When the user input 160 is activated, the timer is reset and the covert indicator is turned off, or changed from a dirty hands indication to a clean hands indication. In some embodiments, the timer is reset automatically when a user uses a dispenser that dispenses soap or sanitizer.

Smart tag 100 includes optional wireless communication circuitry 180. Wireless communication circuitry may be infrared (IR), Bluetooth, BLU, radio frequency (RF), or the like. In this exemplary embodiment, a dispenser (not shown), such as, for example, a soap or sanitizer dispenser, transmits a wireless signal when the dispenser is activated, which is indicative of the wearer obtaining a dose of soap or sanitizer and performing a hand hygiene event. When smart tag 100 receives the signal, the timer is reset and the covert indicator is turned off or changed back from a dirty hands indication to a clean hands indication.

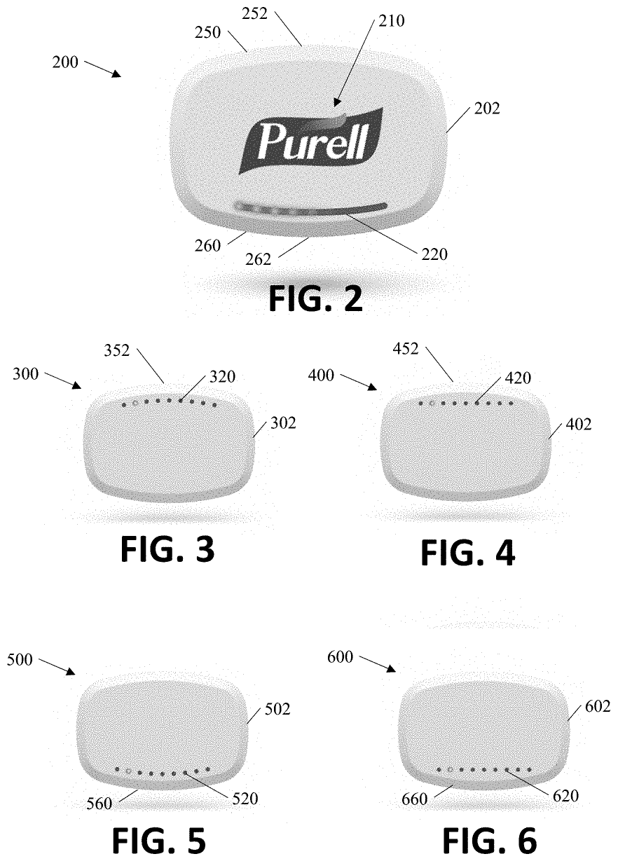

FIGS. 2-10 disclose exemplary embodiments of a variety of smart tags. FIG. 2 is an exemplary embodiment of a smart tag 200. Smart tag 200 has a housing 202. Housing 202 has a top side 250 that has an arcuate shape with an apex 252 located in the center. The bottom side 260 also has an arcuate shape with a valley 262 located in the center of the housing. In this exemplary embodiment, the arcuate shape of top side 250 and the arcuate shape of bottom side 260 are mirror images of one another. In this exemplary embodiment, smart tag 200 has a graphic image 210 that is indicative of a soap or sanitizer brand. The graphical image that is indicative of a soap or sanitizer brand, gives an observer an impression that the wearer takes hand hygiene seriously.

In some embodiments, the graphic image is on a display such as, for example, a LCD or ECD display. In this exemplary embodiment, smart tag 200 includes a light bar 220. Light bar 220 includes a plurality LEDs, which may be the same or different colors. In some embodiments, light bar 220 is a plurality of individual LEDs. Light bar 220 may be a covert indicator, such as, those described herein. In some embodiments, light bar 220 is not a covert indicator and is illuminated in selected patterns, colors, intensities, and the like. Light bar 220 has an arcuate shape and is located along the perimeter of the bottom side 260. In this exemplary embodiment, the arcuate shape of the light bar follows the arcuate shape of the bottom side 260. In such embodiments, the light bar 220 may serve to draw an observer's eye to the smart tag which has the graphic image to indicate that the wearer takes hand hygiene seriously. In some embodiments, smart tag 200 includes a vibrator (not shown). In such an embodiment, the vibrator may be the covert indicator that prompts the wearer to complete a hand hygiene event.

FIG. 3 is another embodiment of a smart tag 300. Smart tag 300 may have all or some of the features describe above. In this exemplary embodiment, the housing 302 of smart tag 300 has the same shape as FIG. 2. Smart tag 300 includes a plurally of LEDs arranged in an arcuate shape along the top side 352 of smart tag 300. The arcuate shape of the plurality of LEDs follows the arcuate shape of the top 352 of smart tag 300.

FIG. 4 is another embodiment of a smart tag 400. Smart tag 400 may have all or some of the features describe above. In this exemplary embodiment, the housing 402 of smart tag 400 has the same shape as FIG. 2. Smart tag 400 includes a plurally of LEDs arranged in an straight line along the top side 452 of smart tag 400.

FIG. 5 is another embodiment of a smart tag 500. Smart tag 500 may have all or some of the features describe above. In this exemplary embodiment, the housing 502 of smart tag 500 has the same shape as FIG. 2. Smart tag 500 includes a plurally of LEDs arranged in an arcuate shape along the bottom side 560 of smart tag 500. The arcuate shape of the plurality of LEDs follows the arcuate shape of the bottom side 560 of smart tag 500.

FIG. 6 is another embodiment of a smart tag 600. Smart tag 600 may have all or some of the features describe above. In this exemplary embodiment, the housing 602 of smart tag 600 has the same shape as FIG. 2. Smart tag 400 includes a plurally of LEDs arranged in an straight line along the bottom side 660 of smart tag 600.

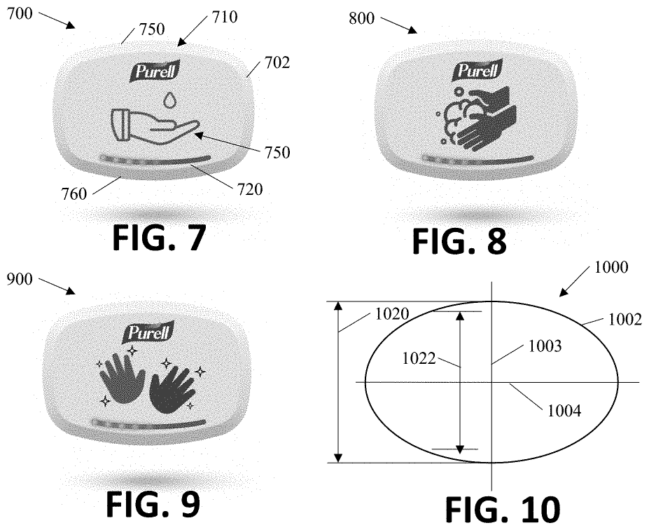

FIG. 7 is an exemplary embodiment of a smart tag 700. Smart tag 700 has a housing 702. Housing 202 has a top side 750 that has an arcuate shape with an apex located in the center. The bottom side 760 also has an arcuate shape with a valley located in the center of the housing. In this exemplary embodiment, the arcuate shape of top side 750 and the arcuate shape of bottom side 760 are mirror images of one another. In this exemplary embodiment, smart tag 700 has a graphic image 710 that is indicative of a soap or sanitizer brand and a hand receiving a dose of soap oar sanitizer. The graphical image that is indicative of a soap or sanitizer brand and a hand, gives an observer an impression that the wearer takes hand hygiene seriously. Either the graphic image of the one or more hands alone or in combination with the brand may convey the same image to the user. In some embodiments, the graphic image is on a display such as, for example, a LCD or ECD display. In this exemplary embodiment, smart tag 700 includes a light bar 720. Light bar 720 includes a plurality LEDs, which may be the same or different colors. In some embodiments, light bar 720 is a plurality of individual LEDs. Light bar 720 may be a covert indicator, such as, those described herein. In some embodiments, light bar 220 is not a covert indicator and is illuminated in selected patterns, colors, intensities, and the like. Light bar 720 has an arcuate shape and is located along the perimeter of the bottom side 760. In this exemplary embodiment, the arcuate shape of the light bar follows the arcuate shape of the bottom side 760. In such embodiments, the light bar 720 may serve to draw an observer's eye to the smart tag which has the graphic image to indicate that the wearer takes hand hygiene seriously. In some embodiments, smart tag 700 includes a vibrator (not shown). In such an embodiment, the vibrator may be the covert indicator that prompts the wearer to complete a hand hygiene event.

FIGS. 8 and 9 illustrate additional exemplary embodiments of smart tags. Smart tags 800 and 900 are substantially the same as smart tag 700 and depict different graphic images of clean hands that are provide a viewer of the badge being worn by a wearer that the wearer takes hand hygiene seriously and has clean hands.

FIG. 10 is an exemplary embodiment of a smart tag 1000. Smart tag 100 has a central vertical axis 1003 and a central horizontal axis 1004. In this exemplary embodiment, the height of smart tag 1000 is greatest at the intersection of the vertical axis 1003 and the housing 1002. The height is reduced away from the vertical axis 1003.

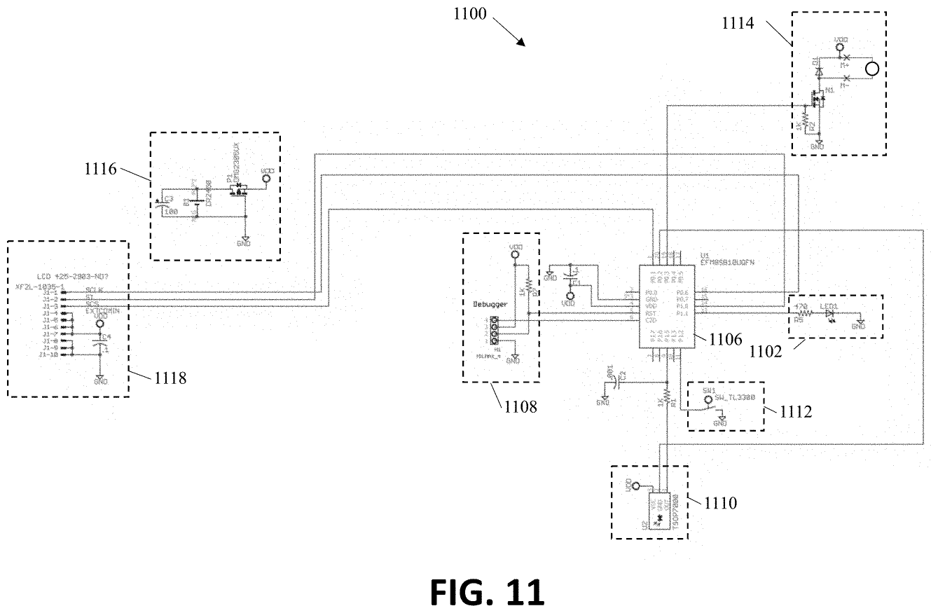

FIG. 11 illustrates an exemplary circuit diagram 1100 for an exemplary smart tag. Circuit diagram 100 includes a power source 1116 that includes a coin cell battery, however, in some embodiments, a different batter is used, such as, for example 3 AA batteries. In some embodiments, the batteries are rechargeable. The circuitry includes a processor 1106, a vibrator circuitry 1114, an light output 1102, which may be one or more LEDs, a switch input 1112, which may be a manual input to reset timer logic to indicate that the wearer has performed a hand hygiene event. In some embodiments, switch input 1112 may be an on/off switch. In some embodiments, switch input 1112 may provide both functions.

Circuitry 1100 includes wireless communication circuitry 1100 which may receive one or more signals from a dispenser or other device proximate a hand hygiene station to indicate that the wearer of the smart tag has washed or sanitized her hands. In this exemplary embodiment, circuitry 1100 includes a display 1118, such as, for example, an LCD display. Vibrator circuitry 1114 provides a covert indication to the wearer that she needs to perform a hand hygiene event. Display 1118 may also provide an indication to the user to perform a hand hygiene event. Optionally, display 1118 does not provide a covert indication to the wearer, but rather provides images, or other graphic designs that are meant to draw the observer's eye to the smart tag and to provide an indication that the wearer of the smart tag takes hand hygiene seriously and gives the observer confidence in their dining experience.

Light(s) 1102 may provide a covert indication to the wearer of the smart tag 110. In some embodiments, light(s) 1102 do not provide a covert indication to the wearer, but merely draw an observers eye. Smart tag circuitry 1100 also includes a header 1108. Header 1108 may be used to reprogram processor 1106. The reprogramming may set or change timers for how long after a hand hygiene event the wearer should perform another hand hygiene event, for how long the covert indicator indicates to the wearer that a hand hygiene event should be completed, how the covert indicator may is reset, e.g. whether the input switch needs to be activated, whether the covert indicator times out, or the like. The display may be programmed with different images and the like.

The exemplary methodologies shown and disclosed herein are exemplary embodiments. In some embodiments, more or fewer steps or blocks may be used. In addition, unless noted to the contrary, blocks or steps may be performed in different orders. Further, steps or blocks in one exemplary embodiment may be added to or removed from other exemplary embodiments.

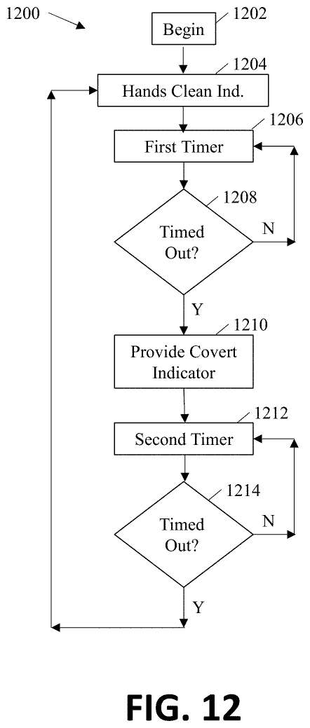

FIG. 12 is an exemplary methodology 1200 or logic diagram for providing a covert indication to a wearer to wash or sanitizer her hands. This exemplary methodology begins at 1202. At block 1204 the smart tag provides an indication to the wearer that the wearer's hands are clean. A timer is started at block 1206. The timer is set for the amount of time that the wearer of the badge may continue activities without needing to conduct a hand hygiene event. The timer may be set at any time, such as, for example, 15 minutes, 30 minutes, 45 minutes, one hour and the like. At block 1208 a determination is made as to whether the timer has timed out. If the timer has not timed out the methodology loops back to the timer at block 1206.

If at block 1208 a determination is made that the timer has timed out, the covert indicator is activated at block 1210. At block 1212 a second timer is started. The second timer is the amount of time the covert indicator will remain activated. At block 1214, a determination is made as to whether the time period has elapsed. If it has not elapsed, the methodology loops back to block 1212. If the time has elapse, the methodology flows back to block 1204.

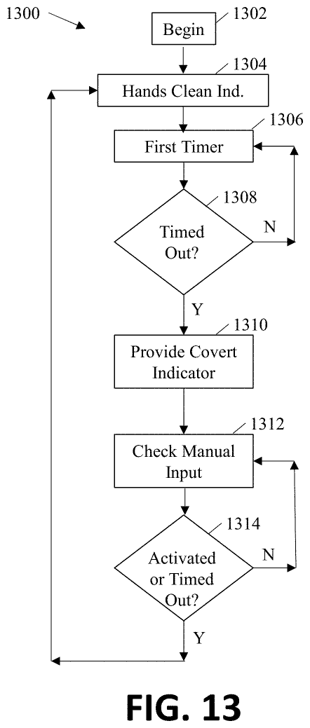

FIG. 13 illustrates another exemplary methodology or logic diagram for using a smart tag to provide a covert indication to a wearer to wash or sanitizer her hands. This exemplary methodology begins at 1302. At block 1304 the smart tag indicates that the wearer's hands are clean. A timer is started at block 1306. The timer is set for the amount of time that the wearer of the badge may continue activities without needing to conduct a hand hygiene event. The timer may be set at any time, such as, for example, 15 minutes, 30 minutes, 45 minutes, one hour and the like. At block 1308 a determination is made as to whether the timer has timed out. If the timer has not timed out the methodology loops back to the timer at block 1306. If at block 1308 a determination is made that the timer has timed out, the covert indicator is activated at block 1310 and a covert indicator timer is set.

At block 1312 a check is made as to whether a manual input has been activated. The manual input may be activated by, for example, a wearer pushing a button on the smart tag. At block 1314, a determination is made as to whether the manual input has been activated or the covert indicator time period has elapsed. If the manual input has not been activated, or the timer has not elapsed, the methodology loops back to block 1312. If the manual input has been activated or if the time has elapse, the methodology flows back to block 1304.

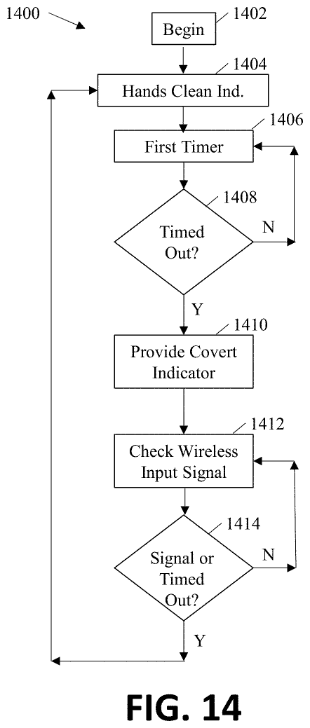

FIG. 14 illustrates another exemplary methodology or logic diagram for using a smart tag to provide a covert indication to a wearer to wash or sanitizer her hands. This exemplary methodology begins at 1402. At block 1404 the smart tag indicates that the wearer's hands are clean. A timer is started at block 1406. The timer is set for the amount of time that the wearer of the badge may continue activities without needing to conduct a hand hygiene event. The timer may be set at any time, such as, for example, 15 minutes, 30 minutes, 45 minutes, one hour and the like. At block 1408 a determination is made as to whether the timer has timed out. If the timer has not timed out the methodology loops back to the timer at block 1406. If at block 1408 a determination is made that the timer has timed out, the covert indicator is activated at block 1410 and a covert indicator timer is set.

At block 1412 a check is made as to whether a wireless communication signal has been received indicative of the wearer washing or sanitizing her hands. At block 1414, a determination is made as to whether the wireless signal has been received or the covert indicator time period has elapsed. If the wireless signal has not been received, or the timer has not elapsed, the methodology loops back to block 1412. If the wireless signal has been received or if the time has elapse, the methodology flows back to block 1304.

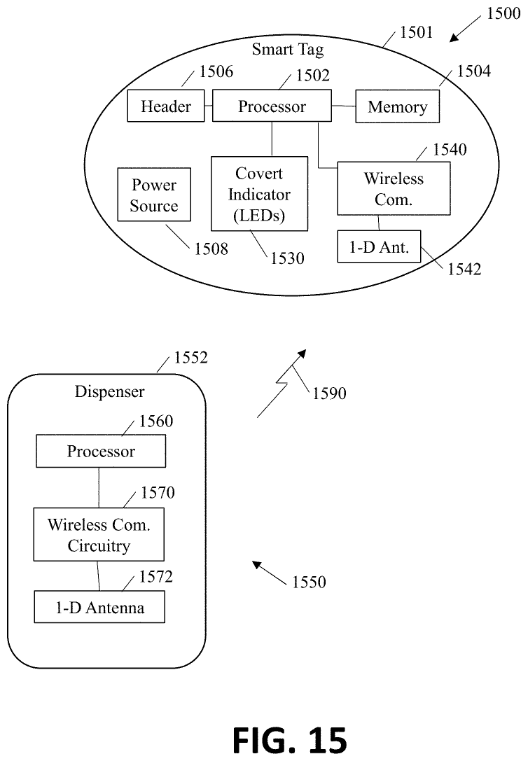

FIG. 15 is an exemplary smart tag 1500 and dispenser 1550. Smart tag 1500 includes a processor 1502, optional header 1506, memory 1504, power source 1508, covert indicator 1530 and wireless communication circuitry 1540, which are similar to, processor 102, header 106, memory 104, power source 108, covert indicator 130, and wireless communication circuitry 1540 and are not redescribed herein. In this exemplary embodiment, power source 1508 is a plurality of rechargeable batteries.

Use of radio technology in the food service industry is challenging. Food service employees often work in very tight quarters and most of the appliances, preparation tables, counters, and the like are made of stainless steel which interferes with wireless signals. It is imperative to ensure the correct smart tag receives signals from the soap or sanitizer dispenser that the wearer of that smart tag has received a dose of soap or sanitizer and the correct smart tag can be reset. To overcome the issues in the food service industry, Smart tag 1500 includes a vertically positioned (1 dimensional) antenna 1542 on the smart tag 1500.

A plurality of dispensers 1550 may be placed throughout the specific food service establishment. Dispensers 1550 may be soap dispensers located by sinks in the kitchen and/or bathrooms. Dispensers 1550 may be sanitizer dispensers located throughout the establishment, including by the doors, service areas, hostess stands, kitchen area, food preparation areas, bathrooms and the like. Dispenser 1500 includes a processor 1560, wireless communication circuitry 1570 located in housing 1552. Dispenser 1500 includes a vertically positioned (1 dimensional) antenna.

A vertical positioned antenna in the smart tag 1500 and a vertical positioned antenna in the dispenser 1550 provided reliable results when the person was facing towards, perpendicular to, or away from the dispenser 1500.

An important criteria in the design of the smart tag is the battery life. One method that was discussed above that greatly increases the battery life is to operate the LEDs at a lower frequency, e.g. 50 hz, and to operate the LEDs with a less than 100% duty cycle, e.g a 10% duty cycle.

In some embodiments, the smart tag 1500 includes a low frequency radio frequency identification device (“LF RFID”) (not shown). The dispenser 1500 includes a low frequency interrogator (not shown). When smart tag 1500 is located proximate the dispenser 1500, the LF RFID receives an interrogation signal from the low frequency interrogator and “wakes” the smart tag 1500 up. The processor 15002 turns on the wireless communication circuitry which waits for a communication from the dispenser 1500 that the dispenser 1500 has dispensed a dose of soap or sanitizer.

In one embodiment, smart tag 1500 does not require wireless communication circuitry other than the LF RFID. When the dispenser 1500 dispenses a dose of soap or sanitizer, it triggers a broadcast of the interrogation signal. In this embodiment, when the LF RFID receives an interrogation signal, smart tag 1500 determines a dose of soap or sanitizer has been dispensed to the wearer of the smart tag 1500 and the timers are reset.

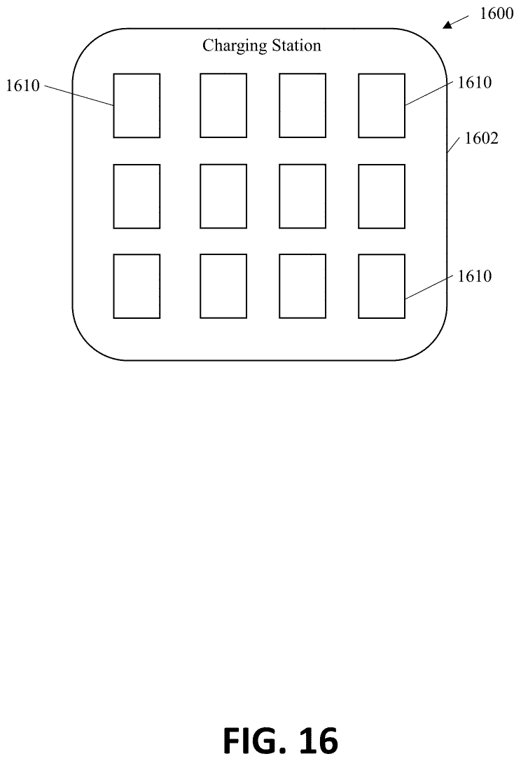

FIG. 16 is an exemplary charging station 1600 for charging the smart tags. Charging station 1600 includes 12 charging ports 1610. In some embodiments, the charging ports include a connector (not shown) to physically connect the smart tags to the charging ports 1610. In some embodiments, the charging station 1600 utilizes inductive charging.

In some embodiments, the smart tags configured as described above have a battery capacity life of about 7-10 days.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. It is not the intention of the applicant to restrict or in any way limit the scope of the appended claims to such detail. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order in which the steps are presented to be construed as required or necessary unless expressly so stated.

I/We claim:

1. A smart tag for covertly alerting a service worker to perform a hand hygiene event comprising:
a housing;
a processor;
memory;
one or more rechargeable batteries;
a vibrator;
wherein the vibrator vibrates the badge,
wherein when the badge is in use and vibrates, the vibrating badge produces less than 30 decibels of sound;
a plurality of LEDs,
wherein the LEDs illuminate in a first sequence to indicated one of the service worker has washed or sanitized her hands and service worker needs to wash or sanitizer her hands; and
a graphic image;
wherein the graphic image depicts one or more hands.

2. The smart tag of claim 1 wherein the plurality of LEDs illuminate in a second sequence to indicate the other of the service worker has washed or sanitized her hands and service worker needs to wash or sanitizer her hands.

3. The smart tag of claim 1 further comprising wireless communication circuitry for receiving a signal from a soap or sanitizer dispenser that the service worker has obtained a dose of soap or sanitizer.

4. A smart tag for covertly alerting a service worker to perform a hand hygiene event comprising:
a housing;
a processor;
memory;
one or more rechargeable batteries;
a covert indicator;
wherein the covert indicator is one of a vibrator for vibrating the badge at a decibel rating of below 30 decibels and one of a plurality of LEDs that illuminate in one or more sequences.

5. The smart tag of claim 4 further comprising a graphic image.

6. The smart tag of claim 5 wherein the graphic image is one of one or more hands and a company logo, wherein the company logo is a logo for one of a soap or sanitizer.

7. The smart tag of claim 4 wherein the housing has an upper surface and a lower surface and wherein the upper surface and lower surface have arcuate shapes.

8. A smart tag for covertly alerting a service worker to perform a hand hygiene event comprising:
a housing;
a processor;
memory;
a vibrator;
wherein the vibrator vibrates the badge,
wherein when the badge is in use and vibrates, the vibrating badge produces less than 30 decibels of sound; and
a power source.

9. The smart tag of claim 8 wherein the vibrating badge produces less than 25 decibels of sound.

10. The smart tag of claim 8 further comprising a plurality of LEDs.

11. The smart tag of claim 10 wherein the plurality of LEDs are located along a periphery of the smart tag.

12. The smart tag of claim 10 wherein the plurality of LEDs are illuminated in a sequential order.

13. The smart tag of claim 10 further comprising logic to cause the sequence of lights to illuminate in a first order to indicate the service worker as completed a hand hygiene event;

14. The smart tag of claim 10 further comprising logic to cause the sequence of lights to illuminate in a second order to indicate the service worker needs to perform a hand hygiene event.

15. The smart tag of claim 8 wherein the housing has a upper side that has an arcuate shape and a lower side that has an arcuate shape and wherein the arcuate shapes are mirror images of one another.

16. The smart tag of claim 8 further comprising a graphic image that contains one or more hands.

17. The smart tag of claim 8 further comprising a graphic image that contains a brand that is indicative of a soap or sanitizer.

18. The smart tag of claim 8 further comprising logic stored in the memory for controlling a timer for the vibrator to operate and logic for turning off the vibrator.

19. The smart tag of claim 18 further comprising a push button for resetting timer;

20. The smart tag of claim 8 further comprising wireless communication circuitry for receiving a signal from a soap or sanitizer dispenser.

21-76. (canceled)
